(19) United States
(12) Patent Application Publication
(10) Pub. No.: US 2007/0095747 A1
(43) Pub. Date: May 3, 2007

(54) Composite fiber environmental filtration media containing flocculant

(75) Inventors: Marc S Theisen, Signal Mountain, TN (US); Kevin S. Spittle, Vero Beach, FL (US)

Correspondence Address: BROOKS KUSHMAN P.C., 1000 TOWN CENTER, TWENTY-SECOND FLOOR, SOUTHFIELD, MI, 48075, US

(73) Assignee: PROFILE PRODUCTS L.L.C., BUFFALO GROVE, IL (US)

(21) Appl. No.: 10/545,510

(22) PCT Filed: May 7, 2004
(86) PCT No.: PCT/US04/14464

§ 371 Date: Aug. 12, 2005

(51) Int. Cl. B01D 39/00

(52) U.S. Cl. 210/503; 210/504; 210/506

(57) ABSTRACT

Filtration media (5) containing natural fiber and a flocculant are effective to flocculate fine particles from runoff in sloped land, ditches, gullies, and construction sites. The filtration media may be in the form of a substantially planar mat product (8), e.g. an erosion control mat, or in tubular form (6).

### BACKGROUND OF THE INVENTION

1. Field of the Invention

The present invention pertains to composite fiber filtration tubes for use in erosion control, sediment control, vegetation establishment, and storm water treatment.

2. Description of the Related Art

Control of surface runoff to prevent erosion has been practiced for millennia. Use of terraced hillsides for agriculture, and construction of low stone walls on hills and in ditches to trap sediment and reduce runoff are widely evident throughout the world. More recently, rolled erosion control products have been used for this purpose, as well as for protecting seed beds and underlying soils for plantings, especially turf establishment (erosion control blankets and turf reinforcement mats).

However, erosion control mats do not always work well alone on steep slopes, and are generally impractical to install over large areas. Moreover, areas where crops are being planted and grown must be kept free of such products. Finally, while erosion control mats can be effective to reduce water velocity and trap larger sediment to a degree, they are largely ineffective at trapping very fine particulates such as colloidal clay particles.

Recently, wattles have been employed to reduce water velocity of surface runoff and to trap sediment. These wattles are essentially mesh tubes filled with natural fibers such as rice straw, wheat straw, coconut, and wood excelsior fibers. The wattles or fiber rolls are placed at intervals across the slope, i.e. perpendicular to the direction of runoff, and are frequently used in conjunction with rolled erosion control products and hydraulic seeding techniques; as illustrated in FIG. 2. In FIG. 2, the wattles 5 are placed at intervals transverse to the slope of the hill, and shorter wattles 6 are placed at intervals in gulley 7. Such a straw wattle is illustrated in FIG. 1, where the wattle 1 comprises a plastic mesh 2 surrounding and encasing straw 3. The netting is fused or tied at the ends 4. Erosion control mats 8 are placed along the hill side as well.

When employed to trap fine sediment, such fiber rolls may also be termed “filtration tubes.” However, tubes specifically designed to trap and flocculate fine sediment have not been commercially available; what “filtration” occurs has been incidental to commercial wattles or fiber rolls whose principle purpose is preventing washout and lowering the velocity of water runoff. A disadvantage of conventional fiber rolls or wattles is their relatively high transportation cost, as their density is rather low, and as they can tolerate little compression to facilitate shipping. A further disadvantage is their limited lifespan. The natural fibers tend to degrade rather quickly, in most cases within a year or two. Use of rice straw, with its relatively high silica content, can extend the useful lifetime, claimed to be up to 3 to 5 years in the low humidity, semi-arid western North American environments. In addition to their use on sloped surfaces, filtration tubes can also be positioned in gullies, channels and ditches.

The sediment holding capacity and filtration capacity are related to numerous properties, including the geometric shape of the filtration tube, composition of the fill material and the fill density. A high fill density may result in more efficient capture of very fine particles such as those found in clay and clayey soils. However, the tradeoff is that such higher packing density both lowers the water filtration rate, which results in overflow under high rainfall conditions and may also causes the tubes to become plugged with sediment particles, losing much of their effectiveness, again resulting in overflow. Conventional straw fiber rolls also do not absorb water easily due to their high lignin content and shape of the rice straw fibers as well as the limited surface area per unit weight of such products. Washout of newly installed straw and wood excelsior fiber rolls can occur due to their light weight and inability to absorb large amounts of water. Colloidal particles, in general are very inefficiently trapped by all such products.

It would be desirable to provide a filtration tube with a fill density such that flow rate through the tube is not unduly compromised, yet which has the ability to control fine sediment, particularly colloidal sediments such as fine clays. It would further be desirous to provide a filtration tube with a high water absorption capacity to rapidly add weight to the filtration tube after installation and upon contact with water. It would further be desirable to provide for erosion control mats and other substantially sheet like mat products which are additionally able to control fine sediment such as but not limited to those of colloidal size.

### SUMMARY OF THE INVENTION

The inventors have surprisingly discovered that environmental fiber filtration media including erosion control mats and filtration tubes of natural fibers can be impregnated with a flocculant which is released over time during runoff conditions, and which causes flocculation of fine particles. As a result, particularly for filtration tubes, the fill density may optionally be reduced, allowing for higher infiltration rates without losing efficiency for trapping fine sediment. Preferred fiber filtration media further contain a crimped synthetic or natural fiber, resulting in the ability to produce a filtration media of lower density and increased flow rates. Filtration media containing wood fiber offer an increased surface area at similar density as compared with straw, wood excelsior and coconut fiber media, thus offering greater filtration and more rapid water absorption.

### BRIEF DESCRIPTION OF THE DRAWINGS

FIG. 1 illustrates a wattle of the prior art.

FIG. 2 illustrates use of fiber filtration tubes of the subject invention to control runoff from sloped surfaces and gullies.

FIG. 3 illustrates one embodiment of a subject invention filtration tube.

FIG. 4 illustrates two embodiments of manufacturing processes of filtration tubes in accordance with limited aspects of the invention.

FIG. 5 illustrates one embodiment of ground water treatment employing both mat and roll fiber filtration media.

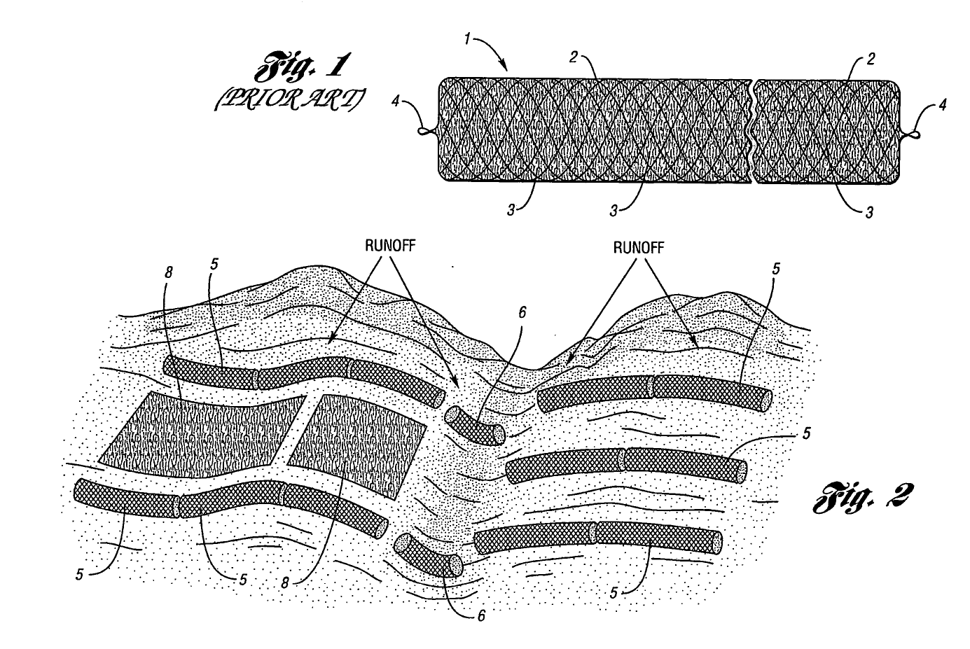

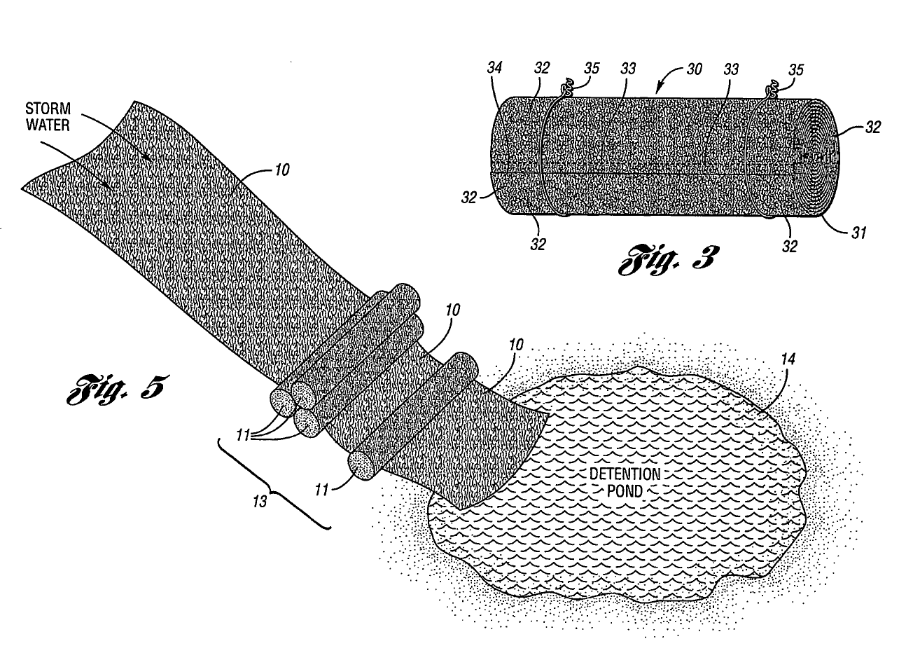

### DETAILED DESCRIPTION OF THE PREFERRED EMBODIMENT(S)

The subject invention filtration tubes have differing utilities as compared with existing fiber roll products. The ability of filtration tubes to capture and flocculate suspended matter allows them to be used in additional applications such as placement around storm water drains, drainage inlets, and gutters. In addition, their absorptive capabilities make them attractive for use in spill containment from industrial, commercial, medical and other markets.

The filtration tubes can be placed in surface storm water flocculation systems to replace the existing flocculant log (Floc-Log) technology. The filtration tubes may provide a more flexible, more adaptable and more efficient flocculent delivery system. The increased flexibility of filtration tubes is an advantage over the rigid block or brick-like Floc-Logs and they may more strategically deployed in surface storm water flocculating systems.

The filtration media of the present invention comprise natural fibers, flocculants, and optionally but preferably, crimped natural or synthetic fibers.

The fibers may be manufactured as a lofty sheet or grid containing flocculant, as hereafter described. These substantially planar mat products may be used as such, or in the case of filtration tubes, may be rolled into a tube. For filtration tube products, fibers may optionally and preferably be introduced into a mesh tube or sleeve, as disclosed by U.S. Pat. No. 5,519,985, herein incorporated by reference, or formed into a tube or roll by any other method.

Methods of manufacturing lofty mats such as turf reinforcement and erosion control mats are well known, as illustrated by U.S. Pat. Nos. 5,330,828; 5,567,087; 5,616,399; 5,484,501; 5,779,782; and 5,302,445, all herein incorporated by reference. Rolling operations are also well known. Following rolling into a tube, the tube may be prevented from unrolling by means of staples inserted at intervals, by tying with wire, string, twine, etc., or by enclosing the roll in a mesh or other porous sleeve. In a particularly preferred embodiment, staples or other devices are used to maintain the roll in its rolled up form, but are not inserted at the edge of the outermost layer, but before the edge, such that before the tube is secured in place, it may be unrolled to the line of staples, thus providing a “skirt” or “apron” upstream or downstream, preferably as an upstream apron. The roll is secured in place by means of wooden stakes or other anchoring devices. By the term “lofty” mat is meant a mat which is compressible in the thickness direction, and thus has “loft” when uncompressed. The usage of the term is consistent with the nature of the erosion control and turf reinforcement mate in general.

In FIG. 3, filter tube 30 consists of a wound roll of lofty mat 31. The mat consists of wood fibers and synthetic crimped fibers, which are not shown in this view for purposes of clarity. The lofty mat also contains polymeric flocculant 32, shown as dots distributed within the roll by virtue of having been distributed within the lofty mat, and/or between layers of mat during rolling of the mat into the tube. An area of greater concentration of flocculant may also be used to encapsulate the filtration tube. This would be accomplished by increasing the amount of flocculant added to the fiber mat at the beginning or end of the roll length. When the fiber mat is rolled into a tube, the beginning or end of the roll would then have elevated concentrations of the flocculent. This would result in more available polymer on the outer portion of the tube to provide increased storm water treatment. A row of staples 33 hold the roll together, but are inserted prior to leading edge 34 of the mat. In this case, the roll is prevented from unwinding to the row of staples by securing with twine 35.

The filtration tubes may also be prepared by methods such as that disclosed in U.S. Pat. No. 5,519,985, in a manner akin to a sausage stuffer. Other methods, for example, are air deposit of fibers into a log shape defined by a netting, placing a woven mesh around the log, or any other method now or hereafter developed may be used.

The natural fibers employed in manufacturing the fiber filtration media, whether the latter is in bulk (log) or lofty mat form, is not limited. Any suitable natural fiber may be used. Considerations affecting the choice of natural fiber include, but are not limited, to the following: cost, geographic availability, availability in suitable length and thickness, weight, water absorption capacity, ability to withstand weathering, and the like.

Suitable natural fibers include wood excelsior, refined wood fibers, coconut, and straw, including rice straw. Suitable fibers also include fibers of cotton, wool, flax, jute, coconut, hemp, grass, and other fibers available directly from natural sources, as well as chemically modified natural fibers, for example chemically modified cellulose fibers, cotton fibers, etc. Suitable natural fibers also include abaca, cantala, caroa, henequen, istle, Mauritius, phormium, bowstring, sisal, kenaf, ramie, roselle, sunn, cadillo, kapok, broom root, coir, crin vegetal, and piassaua. These lists of natural fibers are illustrative and not limiting.

The preferred natural fibers are wood fibers, preferably with mean (number average) lengths of from 0.125 inch (ca. 2 mm) to 2 inches (51 mm), more preferably 0.25 inch (6 mm) to 1 inch (25 mm). However, suitable natural fibers include any available or which can be made available in the requisite lengths, advantageously with an aspect ratio greater than 5, preferably with an aspect ratio of at least 10, more preferably at least 15, and most preferably at least 20.

The natural fibers may be prepared by any convenient manner, for example as disclosed for wood fibers in U.S. Pat. No. 2,757,150, herein incorporated by reference, in which wood chips are fed to a pressurized steam vessel which softens the chips. Any type of wood chip may be used, but wood chips of the soft hardwood varieties, such as yellow poplar and pine are preferred. A defibrator mechanically separates and sizes the chips into individual fiber bundles. The use of thermo-mechanical wood fibers yields several advantages. For example, the wood fibers are highly hygroscopic in nature and allow moisture absorption immediately upon contact with water. This process also helps to maximize surface area of the fibers. This results in reduced water run-off on a project site and minimizes erosion. The ability to conform to the terrain due to increased water absorption acts to more effectively trap sediment which results in much less sediment loss (erosion). Furthermore, thermally treated wood fibers tend to entangle well with optional crimped thermoplastic fibers, adding to the product's strength and dimensional stability in all directions, and thereby improving the ability to handle and install the product.

The optional crimped fibers may be crimped natural fibers or crimped synthetic fibers. Non-crimped synthetic fibers may also be used, with or without crimped fibers. If crimped synthetic fibers are used, it is preferable that these biodegradable, whether by chemical or microbial action, photochemically, or combinations thereof. The term “synthetic fibers,” in this case, includes not only truly synthetic polymers such as polyamides, polypropylenes, polyesters, etc., but also fibers of chemically modified natural substances. Examples of chemically modified fibers include azlon (regenerated natural proteins), regenerated cellulose products including cellulose xanthate (rayon), cellulose acetate, cellulose triacetate, cellulose nitrate, alginate fibers, casein-based fibers, and the like.

Preferred biodegradable crimped fibers include rayon and other chemically modified celluloses, synthetic proteins, chemically modified natural proteins, biodegradable polyesters, polylactic acid (PLA), polyglycolic acid (PGA) and their copolymers, polyester-containing PLA and PLG copolymers, and the like. It is desirable that the biodegradation be effective to leave substantially no long term polymeric residues in the soil after 10 years in a humid environment. Examples of biodegradable polymers are also to be found in U.S. Pat. Nos. 6,573,340; 6,096,809; 5,883,199; 5,798,436; 5,412,005; 5,252,642; and 5,219,646 and references cited therein. All the foregoing patents are incorporated herein by reference.

Preferable non-biodegradable fibers (including those which biodegrade, but with long half-lives) include aromatic polyester, polyamide, polyethylene, polypropylene, etc. Bicomponent fibers of all types are useful, including side-by-side coextruded fibers, core/shell fibers, etc. It is preferable when bicomponent fibers are used, that one component has a lower melting point than the other.

The synthetic fibers which comprise bicomponent fibers preferably have a high melt temperature core and a low melt temperature sheath. It is preferable that the core be polyester and the sheath be polyolefin, preferably polyethylene or polypropylene (including copolymeric polyethylene polymers and polypropylene polymers), and most preferably polypropylene homo- or co-polymers. While the terms “core” and “sheath” are used to describe the bicomponent fibers herein, these terms also include bicomponent fibers having an incomplete sheath, including bicomponent fibers where a strand of high melt temperature polymer abuts, continuously or discontinuously, a strand of low melt temperature polymer. The important consideration is that the bicomponent fiber be an integral fiber containing both polymers, regardless of physical arrangement, so long as the low temperature polymer is not completely surrounded or obscured by the high temperature polymer. By the term “high melt temperature” is meant a melt temperature such that the core of the fiber does not melt and thus lose its integrity under mat or tube consolidation conditions. Some softening of the core is allowable. By “low melt temperature” is meant a temperature at which the sheath polymer melts to the degree necessary to bind the natural fibers and other constituents of the mat together, when this is desired. An example of preferred bicomponent fibers are those available from Leigh Fibers, Inc., of Spartanburg, S.C., having a low temperature sheath melting at about 110° C., and a core which melts at 260° C. (500° F.) or higher. However, other bicomponent fibers are commercially available and useful as well.

Core/sheath bicomponent fibers may be supplied with a concentric or eccentric core; the latter, as well as non-core/sheath bicomponent fibers, e.g. those having a side-by-side morphology, are useful in providing a product with greater loft while employing the same amounts of raw materials. Bicomponent fibers with polyester core and sheaths of polyethylene, linear low density polyethylene, and copolyester are available, as are also bicomponent fibers with a polypropylene core and polyethylene sheath. Bicomponent fibers with a polyamide core are also available. Copolyester sheaths generally have melting points in the range of 130° C. to 220° C., while polyethylene sheaths range from about 90° C. to 130° C. Polypropylene in core products generally melts at about 175° C., while polyester cores may melt from 200° C. to 250° C. or higher.

The melting point of a sheath fiber or core fiber is dependent, of course, on its chemical makeup, and partially dependent on its molecular weight. Thus, lower molecular weight and to some degree oligomeric products tend to have lower melting points, while incorporation of comonomers, such as 1-butene and 1-octene in polyethylene, generally also lower the melting point. For “homopolyesters,” polyethyleneterephthalate (PET) has a lower melting point than polyethylenenaphthalate (PEN). Many combinations are possible, and commercially available. Bicomponent fibers are also available from Fiber Innovation Technology, Inc., Johnson City, Tenn., and ES Fibervisions, Inc., Athens, Ga. The bicomponent fibers may comprise any weight percentage up to 100 weight percent of total synthetic fibers, each percentage between 0 weight percent and 100 weight percent considered herein as individually disclosed.

The synthetic fiber component preferably comprises conventional synthetic fibers other than bicomponent fibers. Such fibers may include fibers of relatively low melt temperature, i.e., which will melt under consolidation temperatures, and those of relatively high melt temperature, i.e., which will remain integral under consolidation conditions, when consolidation is employed. The terms “relatively” low and “relatively” high are used to describe the melt temperatures of the non-bicomponent fibers, since melting of these fibers is dependent upon the consolidation temperature which is in turn dependent upon the melting point of the low melt temperature portion of the bicomponent fibers when the latter are used. A “relatively low” melt temperature fiber will exhibit at least some melting during consolidation, while “relatively high” melt temperature fibers will exhibit no melting whatsoever. Thus, the relatively low melt temperature fibers may assist in bonding of the product, with greater assistance in this respect as the consolidation temperature increases, while relatively high temperature fibers generally produce no increase in binding, but an increase in tensile strength and dimensional stability of the mat due to these fibers retaining their integrity during consolidation.

Relatively high melt temperature fibers include polyester fibers, polycarbonate fibers, polyamide fibers, rayon fibers, polyvinylalcohol fibers, polyvinylacetate fibers, polyacrylonitrile fibers, carbon fibers, and the like. Preferably, the relatively high melt temperature fibers are rayon fibers, polyester fibers, particularly polyethylene terephthalate fibers, or polyamide fibers. The fibers may be virgin fibers, fibers obtained as recyclable products from textile and/or carpet manufacture, or any other source. The relatively high melt temperature fibers are preferably crimped, as disclosed in U.S. Pat. No. 5,779,782, herein incorporated by reference.

The synthetic fibers may have a denier of preferably from 2 to 64, more preferably 4 to 32 denier. Relatively high melt temperature synthetic fibers may range in length from ¼ inch (6 mm) to a length which is still practical for lay up of mats, e.g., several inches (50 cm) or more in length, when rolled mats are used as filtration tubes, or which allow fill of polymer netting for “bulk” tubes or logs, for example those produced by augering the fill into netting. A mixture of fiber lengths may be used. Such mixtures are particularly useful when some long fibers, i.e., those between 1 inch (25 mm) and 2-3 inches (50-75 mm) are employed. For example, a mixture of 10% by weight of fibers having lengths from 1 to 2 inches (25-50 mm) and 90% by weight in the range of ¼ inch (6 mm) to ¾ inch (19 mm) may be especially useful, as the longer fibers will aid in imparting greater tensile strength and tear strength, yet will be present in amounts such that traditional air- or water-laying fabrication techniques can be used. Longer fibers also aid in providing a dimensionally stable but low density product, as discussed hereafter.

The relatively low melt temperature fiber length is less important than that of the high melt temperature fibers, as these fibers partially or substantially melt during the consolidation, when consolidation is employed. For purposes of ease of fabrication, it is desirable to avoid low melt temperature fibers of greater than 2 to 3 inches (25 mm-75 mm) length, as fabrication may be rendered more difficult. Preferred fiber lengths are as low as ⅛ inch (2 mm) or lower, particularly when the entire mat surface is to be melt-consolidated, but preferably range from ¼ inch (6 mm) to 3 inches (19 mm) in length, more preferably 1 to 2 inches (25 mm to 50 mm).

The bicomponent fibers are preferably supplied in lengths similar to those of the high melt temperature conventional synthetic fibers, and at deniers of from 2 to 64, preferably 4 to 32.

The crimped fibers may also include crimped natural fibers, preferably permanently crimped natural fibers as disclosed in U.S. Pat. No. 6,360,478, herein incorporated by reference. The natural fibers preferably are not simply mechanically crimped, as purely mechanical crimping, for example between partially intermeshing toothed rollers, creates a crimped product which is incapable of retaining the necessary set following application, particularly in high humidity or wet (i.e., rain) environments. Rather, it is preferable that crimping be performed at a temperature which is such to cause thermal (i.e., plasticization) or chemical (i.e., crosslinking or degradation into adhesive-like decomposition products) changes which cause the crimp to be maintained even in the presence of light and moisture. In some cases, the fibers may be treated with a coating or impregnant which allows the fibers to retain their set without modification of the fibers per se. Examples of such coatings are methylolurea resins, phenol formaldehyde resins, melamine formaldehyde resins, urea formaldehyde resins, furfural-derived resins, and the like. Many of these resins are commercially available, and are used as binders, for example in fiberglass products, or in fabric treatment to bestow anti-wrinkle performance. In the present case, the coatings are applied and cured before, during, or after the crimping operation, to make permanently crimped fibers as opposed to their normal use in keeping fibers straight (i.e., in wrinkle free fabrics). These resins, due to their thin coating and chemical content, are themselves biodegradable. Some of the resins perform a fertilizing function as they degrade over time, i.e., melamine-formaldehyde, urea-formaldehyde and urea-melamine-formaldehyde resins. Other resins, e.g., epoxy resins, novolac resins, etc., may also be used. However, they are, in general, less biodegradable than the resins previously identified, as well as being more expensive.

Thus, when crimped natural fibers are desired, the fibers may be heat and/or steam treated, or may be crimped prior to cure of a curable coating and/or impregnant, or may employ a combination of such techniques, to create a permanently crimped fiber. Chemically modified natural fibers such as cellulose acetate cellulose triacetate, and cellulose nitrate may be crimped at, above, or near their softening point. Unmodified lignocellulosic fibers such as cotton, flax, wool, etc., must in general be heated to relatively high temperatures, often in the presence of moisture (i.e., superheated steam) to, for a time sufficient to partially break down some of the lignocellulosic or proteinaceous components.

Wood fibers, for example, and those of jute and coconut, may be heated in a moist atmosphere to a temperature and for a time where the fibers turn from golden brown to dark brown and are then crimped. Under these conditions, a natural adhesive is formed as a degradation product, as taught by U.S. Pat. No. 5,017,319 and European Patents EP 0 161 766 and EP 492 016, herein incorporated by reference. Fibers crimped in this condition and then cooled, will have a set which allows the crimps to be maintained over an extended period of time, even in the presence of moisture.

The crimping conditions vary with each type of fiber, its source, and its method of preparation. Finding suitable crimping conditions is straightforward, however, and involves, for natural fibers without coatings, passing the fibers through crimping devices at various temperature and moisture levels, and testing for permanent crimp by exposing the crimped fibers to a warm, high, humidity environment. For example, the fibers may be placed in a metal tray in an environmentally controlled oven and periodically sprayed with a mist of water.

When a coating and/or impregnant is used, the fibers may be crimped mechanically and then sprayed with a solution or dispersion of the coating/impregnant material, or may be first contacted with the solution or dispersion and then crimped. In either case, the crimping and coating operations may be consolidated such that a crimped product containing a coating or impregnated with a cured resin is obtained. For example, crimped fibers may be transported by hot air through a conduit into which a mist of phenol/formaldehyde resin is introduced, the temperature, air flow and turbulence being such that the resin substantially cures without excessive agglomeration of fibers. Alternatively, fibers may be transported on a belt or other transportation device in an uncrimped state, sprayed with curable resin and dried at a temperature insufficient to cause the resin to cure. The fibers, now coated with dry, curable resin, are then crimped at a higher temperature at which the resin cures. Alternatively, the coated fibers are crimped at a low temperature at which the resin does not cure, and are subsequently cured in a heated chamber or conduit. Fibers which become partially agglomeration in any of these processes may be mechanically separated, preferably immediately after curing of the resin, or during resin cure. It is preferable that less than 20 weight percent of all natural fibers are permanently crimped natural fibers, more preferably less than 10 weight percent, and yet more preferably less than 5 weight percent.

The natural fibers may also include waste from textile processes where cloth, yarn, or thread of cotton, linen, wool, silk, etc., are used. Paper fibers and flakes may also constitute a portion of the total natural fiber, preferably not more than 30% by weight, more preferably less than 10% by weight, yet more preferably less than 5% by weight. It is preferable that 80-100%, more preferably 90-100% of the natural fibers be wood fibers. In lieu of a large percentage of wood fibers, it is preferable that the natural fibers comprise wood fibers admixed with inexpensive natural fibers such as cotton, flax, sisal, jute, hemp, coconut, grass, straw, and the like. The most preferred natural fibers are conventional fibers, preferably wood fibers.

It is highly preferable that filtration tubes maintain their dimensions. In general, if a tube of too low a density is manufactured, the fibers may settle of their own accord, or during only modest handling. Thus, for any fiber combination, there is in general a minimum density which is practical. Applicants have surprisingly discovered that addition of crimped fibers to natural fibers allows filtration tubes having a density approximately 10 to 20% less than a similar tube formed of natural fibers alone. This causes the filtration tubes to be more flexible and improves conformability to the substrate. The increased flexibility enables the product to be bent or otherwise shaped to accommodate changing substrate or application geometries. Shipping weight is also lowered. However, an additional advantage is that these filtration tubes can stand modest compression during shipping, following which they may recover to substantially their original shape. Thus, more product can be shipped in a given capacity carrier. In relatively low density products, shipping volume is often a greater constraint than shipping weight. With respect to planar products, addition of crimped fibers allows for retention of loft, as well as providing for at least modest recover following compression during shipping. The crimped fibers also increase the tensile and tear strength of these mat products, to facilitate their handling during manufacturing, shipping, and field installation.

The amount of crimped fibers desirable will vary with the type or types of natural and non-crimped synthetic fibers employed, and their physical properties, i.e. average length, diameter, density, modulus, size distribution, etc. The amounts useful may be measured simply by forming filtration tubes or mat with a range of crimped fiber content. The minimal content which allows for retention of tube density or mat loft and/or recovery (pre-installation, of course), is the preferred amount, or a slightly larger amount to take into account process variations and variation in the properties of the natural fibers.

Preferably, the crimped fibers are rayon, having an average fiber length of 2 inches and a range (90%) of 0.5 to 4 inches, a fiber denier of 15, with a range of 4 to 100 also being suitable. The amount of crimped fibers may range up to about 20% by weight. However, it would be uncommon to employ more than about 10-12% by weight. Amounts of about 3% to 9%, more preferably 6-8% are eminently suitable.

The integrity of the subject invention filtration media may be increased by incorporation of adhesive substances. The adhesive or adhesives may be supplied in any convenient form and in any convenient manner. For example, powdery adhesives may be dusted, spray applied, etc., while similar adhesives may be applied in the form of aqueous solutions or dispersions. The adhesives may be applied as the fibers are augered into their casing, beforehand, or following preparation of the filtration tube.

Examples of suitable adhesives include redispersible polymer powders such as those based on vinyl ester homo and copolymers, vinyl ester/ethylene copolymers, vinyl ester/acrylate copolymers, styrene/butadiene copolymers, polyvinyl alcohol polymers, polyvinyl acetal polymers, and the like. Such adhesives are generally thermoplastic, i.e. they adhere by softening or fusing, or by being inherently tacky. Also suitable are natural adhesives such as casein-based products, hide glue, fish glue, modified starches, alginates, gums, and the like, and the thermoset adhesives such as novolac resins, epoxy resins, urea/formaldehyde, melamine/formaldehyde, phenol/formaldehyde and similar condensates, generally in the form of dispersions. When adhesives are employed, they are preferably employed in amounts of 0.1 to 10% by weight, more preferably 0.5 to 5% by weight. Adhesives are preferably absent.

A necessary component of the subject invention filtration tubes is a flocculating agent. Both inorganic and organic flocculating agents, and combinations thereof, are useful. Preferred flocculating agents are anionic acrylic polymers, preferably anionic polyacrylamide. Many such flocculating agents are known, for example, organic flocculants which include nonionic, anionic, cationic, zwitterionic and other polymers, particularly polyacrylates, polyacrylate copolymers, polyacrylamides, polymethacrylamides, polyacrylamide/aerylic acid copolymers, polyamines, polyimines, melamine/formaldehyde condensates, etc. A range of polymeric flocculants are available from Ciba Specialty chemicals under the tradenames Magnafloc® and Zetag® flocculants. Inorganic flocculants include lime, alum, ferric chloride, polyaluminum chloride, polyferric sulfate, sodium alginate, and bentonite, among others. Selection of flocculants is discussed in A. Greville, “How to Select a Chemical Coagulant and Flocculant,” ALBERTA WATER AND WASTEWATER OPERATORS Assoc., 22th Annual Seminar, Mar. 11-14, 1997.

Examples of flocculants and their use are disclosed in U.S. Pat. Nos. 3,957,904, 4,024,216, 4,155,847, 4,251,363, 4,370,464, 4,431,548, 4,990,263, 5,019,275, 5,035,808, 5,326,854, 5,725,780, 5,990,216, 6,531,531, 6,569,968, all herein incorporated by reference.

A preferred flocculating agent is a linear anionic polyacrylamide copolymer with a charge density of about 30%, and a molecular weight of 2-6 25 Kg/mol, more preferably approximately 15 Kg/mol, and a viscosity (Brookfield number 2 spindle, 25° C.) of 400 to 5000 cps, preferably 1900 cps.

The flocculant is preferably supplied in a variety of sizes, so as to provide for sustained release. The flocculant form may be that of particles, extrudates, etc. When particles are employed, it is preferable that the particles span a size range of about 25 to 6000 μm, more preferably 200 to 2000 μm. For polymeric flocculants of high enough molecular weight, the flocculant may be melted and extruded into filaments, preferably into filaments of differing diameters. These flocculant fibers may be straight or crimped, or in the form of helices, etc. Following extrusion, the flocculant filaments are generally chopped into short lengths, in general less than 10 cm long, preferably in the range of 1 mm to 7 cm, and more preferably in the range of 1 cm to 6 cm. When supplied as short filaments, the filaments can be incorporated into the filtration tube in the same manner as the natural fibers and kinked fibers. In filament form, the flocculant also assists in maintaining the loft of the filtration tube, thus allowing for yet lower densities, and aids in shape recovery after compression as well. Furthermore, being in filament form, particularly in kinked filament form, the loss of flocculant from the filtration tube during handling is lowered.

The amount of flocculant is calculated from a designed water flow, assuming a given amount of fine sediment which requires flocculation. These calculations are easily made by one skilled in the art of particle flocculation. The higher the expected water treatment capacity, the higher the amount of flocculent, and, in general, the more the flocculant size will extend into the higher portion of the size range. For example, when employing an anionic polyacrylamide flocculant, the amount of flocculant may range from 0.25 grams per linear foot (ca. 0.8 g/m) of filtration tube to as much as 25 grams per linear foot (ca. 80 g/m) or more. An amount of about 2 g/ft. (ca. 7 g/m) is sufficient to treat about 240,000 gallons (910,000 liters) of water in a filtration of normal length. Treatment of 50 to 500 gallons (190 to 1900 liters) per lineal foot of (30 cm) of filtration tube, more preferably 100 to 350 gallons (380 to 1330 liters), and most preferably 150 to 250 gallons (570 to 950 liters) per lineal foot are easily possible. A level of flocculant necessary to treat approximately 218 gal/ft (ca. 2700 liters/m) are most satisfactory. The quantity of flocculant in mat products is analogous to that of the filtration tubes based upon their respective volumes.

The filtration tubes may be made in numerous sizes and lengths depending upon the desired application, and the kind of shipping available.

Preferred diameters are 6 inch (15.2 cm), but diameters between about 3 inches (7.5 cm) or less to in excess of 20 inches (0.5 m), preferably from 6 inches (15.2 cm) to 9 inches (23 cm) are also useful. For use in gullies, ditches, channels, etc., larger diameters may prove quite useful. The filtration tubes may also be fabricated in other geometric orientations than cylinders. For example, triangular-shaped tubes will maintain greater soil contact and may be more stable on steep slopes and in channels. Shapes such as those having triangular or square cross-sections may be prepared by providing an encapsulating netting having such a shape. Alternatively, mat products may be wound around a triangular, square, or other shaped mandrel, which is later removed. Retention of geometric shape in such cases is facilitate by including low melting thermoplastic fibers or thermoplastic adhesives into the mat or between mat layers, which can be fused and set by brief passage through an oven or by radiant heat, microwave heat, or hot gas. Alternatively, a thermosettable adhesive such as a urea/formaldehyde, melamine/formaldehyde, or urea/melamine/formaldehyde condensate may be applied, for example in particulate form, but preferably in the form of a solution or emulsion. The thermosettable adhesives generally but not always require oven cure. An advantage of the three thermoset adhesives just mentioned is their slow degradation into nitrogenous products which serve as fertilizers or which are ultimately biodegradable into ammonia or organic nitrogen-containing compounds, CO₂, etc.

Mat products may be made in any practical width, e.g. 3 to 20 feet, preferably 4 to 12 feet and generally in a continuous length which is cut to size to form a roll of suitable diameter for shipping and handling. The mater products may be single layer, in which case the flocculent is preferably added during their preparation, i.e. by an air laying process, or may comprise a plurality of layers, with the flocculent located between adjacent layers. Combinations of flocculant location are of course possible. When multiple layers are utilized, the layers may be consolidated together by all conventional processes, for example thermal bonding, adhesive bonding, needling with barbed needles, stitching, etc. The mat products may also include a fiber netting to assist in maintaining mat integrity, although use of such netting is not preferred. When such netting is used, it is preferable that the netting constitute filaments of an extruded flocculant, or filaments of biodegradable polymer, or both. Use of a netting of polymeric flocculant may supply all or a portion of the flocculant desired to be contained in the mat product.

The amount of flocculant in mat products may be the same, on a volume basis, as that contained in filtration tubes. However, the amounts may be lesser or greater depending upon the nature of the soil onto which they are to be applied, the expected lifetime of the mat, the frequency of precipitation and its amount, etc. Amounts of from 0.1 g/m² to 200 g/m² or more are useful, preferably 1 g/m to 50 g/m, and most preferably 1 g/m to about 20 g/m. Mats with these amounts of flocculent may also be rolled into filtration tubes of any cross-sectional shape.

As indicated previously, the filtration tubes may be manufactured by techniques well known to those skilled in the art in the manipulation and packaging of fibrous materials, particularly the textile industry and turf reinforcement mat or erosion control blanket production. For example, natural and synthetic fibers are often shipped in compressed or uncompressed bales, and are “opened” into individual fibers or bundles of fibers by conventional staple fiber “openers.” Similar openers have been used in the manufacture of traditional erosion control blankets from natural fibers and turf reinforcement mats from synthetic fibers.

Likewise, natural fibers, whether crimped or uncrimped, are also generally supplied in compressed bales, as also may be flaked paper products, jute, hemp, sisal, and other fibers. When supplied as a bale, these products are also “opened.”

Following “opening,” the fibers may be treated in any manner which results in thorough admixing. One such method is to apply the various fibers to a running belt, on which they are carded by conventional carding rolls. Following carding, they may be further mixed, by machinery similar to an “opener,” and either laid as a mat or forwarded to a holding bin for insertion into plastic mesh.

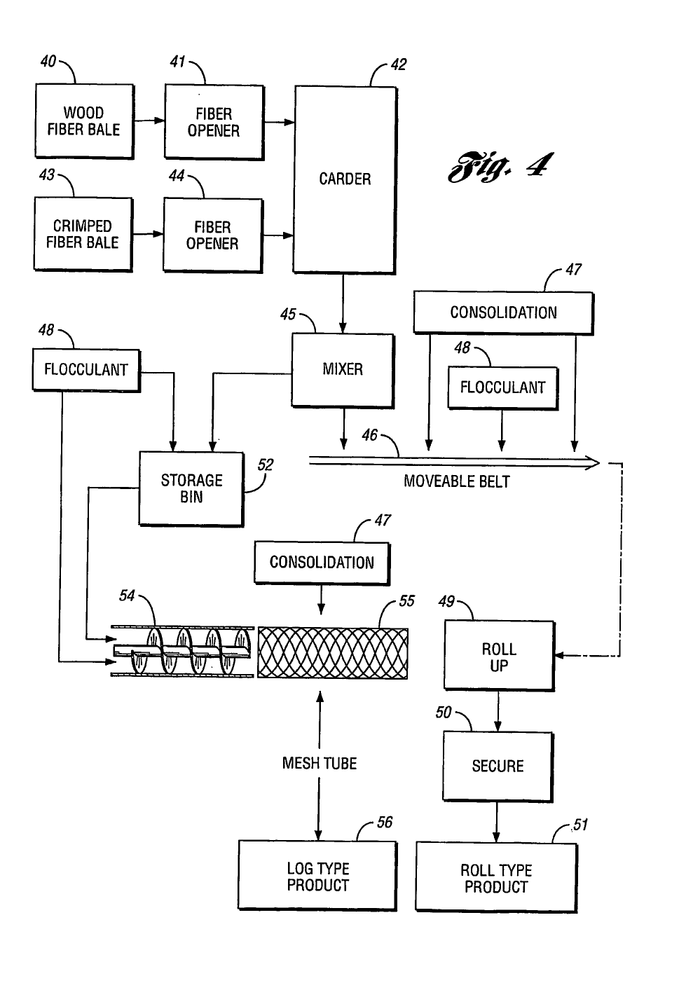

A schematic of two manufacturing processes is shown in FIG. 4. These are not limiting, however, and other processes may be used as well. In FIG. 4, wood bale 40 is opened by opener 41 and fed to carder 42; and crimped fiber bale 43 is opened by opener 44 and similarly fed to carder 42. The carded product is then fed to mixer 45. If rolled-up mat products are to be produced, the mixed fibers from the mixer may be applied to moving belt 46 to form a lofty mat. The lofty mat may optionally be consolidated 47 i.e. by infrared heat, passage through an oven, etc., either prior to adding flocculant 48, after adding flocculant 48, or both. If heated to above the melting or softening joint of the flocculent, the latter may also serve as a binder, and will also be more resistant to loss during handling. The mat is generally not consolidated between rollers, unless the pressure is very moderate, as otherwise the density will increase. The mat product is rolled 49, and secured 50, resulting in a finished roll-type product 51. The step of securing may include tying, stapling, enclosing in a mesh “envelope,” or any other means of ensuring that the product does not unroll and is easily handle. In one non-limiting embodiment of securing, staples are inserted into the roll short of the end of the rolled mat so that the mat may be partially unrolled on site to provide an apron. In a further, non-limiting embodiment, the outside of the roll may be exposed to heat, preferably infrared light, to melt fusible fibers, adhesives or particles in the outermost and optionally penultimate layers, to serve as a binder for the outside of the roll product only, the inside being principally unbound. The roll may be partially pressured from the outside during this optional consolidation to enhance the consolidation process.

For log-type products, the mixed fibers from mixer 45 may be conveyed directly to auger 54 into which flocculant 48 may also be directly added, or may be conveyed to storage bin 52 to which flocculant 48 may be added. The flocculent may be added both to the fibers in the storage bin and directly to the auger if desired. From the storage bin, the fibers and flocculant if present, are delivered to auger 54 where they are augered into a mesh tube 55, and optionally consolidated by the same means previously described or other means of consolidation such as traverse through a heated oven, microwave heating, etc., as may also be used for the roll product. The final product is a mesh-encased log 56.

When netting, mesh, string, twine, geotextile, etc., are used to wrap or secure the filtration tubes, whether in log form or roll form, it is desirable that these securing means themselves be biodegradable. Netting and mesh products may be made from the thermoplastic biodegradable polymers discussed earlier, for example, or in some cases, may be woven loosely from natural fibers such as cotton, linen, jute, hemp, sisal, etc.

Consolidation is an optional step in all processes, and generally requires the addition of low melt temperature fibers in lieu of or in addition to the crimped fibers, or an adhesive substance. Consolidation is generally conducted under no or modest compression, whether a mat intermediate is to be consolidated, or the final roll-type or log-type product is to be consolidated. Only an amount of pressure which is necessary to cause the softened or melted fibers to contact the other fibers to provide the desired degree of bonding is necessary. Thorough bonding is generally not necessary, although it may be preferable to more thoroughly bond the exterior of either type of product while leaving the interior less thoroughly bound or unbound.

As indicated previously, the flocculant may be added at temperatures where it will also bind to the other fibers to form a coating on the fibers. The flocculant may also be added at a low temperature and then heated to achieve the same effect. The flocculant may also be added along with water in the form of a high humidity level, a mist of water, steam, etc., or to wood fibers with a relatively high level of moisture, so as to become tacky. The tackiness further adds to binding power and also helps prevent loss of flocculating agent.

FIG. 5 illustrates a further embodiment, in which combined use is made of flocculant-containing erosion control mats 10, preferably comprising wood fibers, and fiber filtration tubes 11, all positioned in the path storm water would take, for instance but not by limitation, a shallow gully or depression. At steeper portions, i.e. at 13, fiber tubes are placed across the direction of flow to decrease water velocity, and to weight down the erosion control mats at these points. Both the filtration tubes 11 and the erosion control mats 10 preferably contain time release flocculent. However, it is also possible to have flocculant contained only in the mats 10, or only in the filtration tubes 11. Runoff typically is caught by a storm water basin or detention pond 14. The flocculant which is released by the mat(s) and/or filtration tube(s) causes colloidal sediment to flocculate into larger particles which generally sediment to the bottom of the detention pond. These sediments may remain in the pond or may be removed at periodic intervals, depending upon site requirements.

### EXAMPLE 1

A filtration tube is prepared from 93 parts by weight thermally refined wood fibers having a minimum classifier value 40% as a #8 sieve via Ro tap analysis, a fiber range of 15% to 65% retainage, and 7 parts by weight of rayon fibers having a denier of 15 and fiber lengths substantially between 0.5 inch (1.27 cm) and 4 inches (10.2 cm), average length 2 inches (5.1 cm). The fibers are supplied in bales, opened, carded, mixed, and stored in a holding bin to which flocculant is introduced, and mixed by slowly revolving beater bars which also serve to direct the fiber mixture to the auger. The mixed fibers and flocculent are introduced by means of an auger of somewhat less than 6 inch outside diameter, into a forming tube of slightly less than 6 inch inside diameter, the end of the tube being covered by the closed end of a six inch diameter cylindrical plastic net. The amount of flocculent is 2 g/lineal foot (2 g/30 cm). As the fiber mixture exits the tube, it fills the net, generating a lengthy log-type, mesh-encased product. The net may be positioned around the tube precut to the desired length, or may be woven in place by a multidimensional weaving machine. The diamond pattern netting openings measure approximately 0.5 inch (1.27 cm) square. The finished 6 inch tube has a density of about 0.85 g/in³ (0.052 g/cm³).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A filtration medium suitable for use when flocculation of fine particles in flowing water is desired, comprising components
a) natural fibers in an amount of about 20 to 100% by weight;
b) optionally, up to about 20% by weight crimped fibers; and
c) at least one flocculant,
wherein the percents by weight of a) and b) are relative to the sum of the weights of a) and b).

2. The filtration medium of claim 1, in the form of a filtration tube of rolled-up lofty mat.

3. The filtration medium of claim 1, wherein components a), b), and c) are contained within a polymer netting.

4. The filtration medium of claim 1, wherein said natural fibers comprise thermally treated wood fibers.

5. The filtration medium of claim 1, wherein said flocculant comprises an anionic polyacrylamide copolymer.

6. The filtration medium of claim 5, which comprises a filtration tube, and wherein said flocculant is present in an amount of 0.25 g to 10 g per 30 lineal cm.

7. The filtration medium of claim 1, wherein said crimped fibers comprise rayon and are present in an amount of from about 2 to about 10 weight percent.

8. The filtration medium of claim 1, wherein a flocculant is supplied in both small particles and large particles such that said filtration medium is able to release flocculent over a plurality of periods of runoff.

9. The filtration medium of claim 1, wherein at least a portion of said flocculant is in the form of extruded filaments.

10. The filtration medium of claim 1, comprising a filtration tube, wherein said fibers and flocculant are encased within a mesh sleeve.

11. The filtration medium of claim 1, wherein said crimped fibers comprise biodegradable fibers.

12. The filtration medium of claim 1, which is a filtration tube comprising a roll of a lofty mat of fibers.

13. The filtration medium of claim 12, wherein said roll is prevented from unrolling by being bound together by a binding means.

14. The filtration medium of claim 1, which is in the form of a substantially planar lofty mat product.

15. The mat product of claim 14 which is in roll form.

16. The mat product of claim 15, further comprising a fiber netting of biodegradable polymer or of strands and/or filaments of a polymeric flocculent.

17. A process for treating runoff water to remove fine particulates contained therein, said process comprising positioning in the path of said runoff water, at least one a filtration medium of claim 1.

18. A process for flocculating colloidal particles in a flowing stream of surface water, comprising placing in the path of said stream, at least one filtration medium of claim 1.

19. The process of claim 15, wherein said flowing stream is from a construction site.

20. The process of claim 18, where said flowing stream comprises water in a gulley, a storm drain, a drainage inlet, or a gutter.

21. The process of claim 17, comprising applying to an outdoor site at least one erosion control mat and at least one fiber filtration tube, at least one of said erosion control mat(s) or said filtration tube(s) containing a flocculant in an amount such that fine sediment and/or colloidal particles in surface water flowing past said erosion control mat(s) and/or filtration tube(s) are caused to flocculate into large particles.

22. The process of claim 17, wherein both said erosion control mat(s) and said filtration tube(s) contain a flocculant.

23. The process of claim 21, wherein the size of flocculant is such that release of flocculant will continue through a plurality of periods of surface water generation by precipitation.

24. The process of claim 23, wherein said flocculant is released from at least one of said erosion control mat(s) or filtration tube(s) for a period of two years calculated on the basis of predicted rainfall at said outdoor site.

25. The process of claim 21, where at least one of said erosion control mat(s) contains polymeric flocculant in an amount of from 0.1 g/m² to 100 g/m^{2.}
